(19) United States
(12) Patent Application Publication
(10) Pub. No.: US 2008/0138080 A1
(43) Pub. Date: Jun. 12, 2008

(54) CONTROLLER DETECTION

(75) Inventors: RAYMOND E. TYRRELL, BEAUFORT, NC (US); COLLINS WILLIAMS, RALEIGH, NC (US); JONATHAN HUFFMAN, RALEIGH, NC (US); TRAVIS LENTZ, RALEIGH, NC (US); DOUGLAS LAYNE, BENSON, NC (US)

Correspondence Address: ALCATEL LUCENT;INTELLECTUAL PROPERTY & STANDARDS, 3400 W. PLANO PARKWAY, MS LEGL2, PLANO, TX, 75075, US

(73) Assignee: ALCATEL LUCENT, Paris (FR)

(21) Appl. No.: 11/839,249

(22) Filed: Aug. 15, 2007

Related U.S. Application Data
(60) Provisional application No. 60/869,264, filed on Dec. 8, 2006.

(51) Int. Cl. H04B 10/00

(52) U.S. Cl. 398/151

(57) ABSTRACT

In an Optical Network Termination (ONT), a software controlled system, method and computer readable medium includes measuring a modulation current of an upstream laser transmission. The measured modulation current is processed to determine if a continuous transmission state is present, in response to which, a processor of the ONT sends a signal to shut down the upstream laser transmission. The software solution allows reconfigurable parameters including sample rate and shut down procedure.

### CROSS REFERENCE TO RELATED APPLICATIONS

The present patent application is related to and claims the benefit of provisional patent application No. 60/869,264, filed 8 Dec. 2006, entitled Controller Detection, the entire contents of which are incorporated by reference herein.

### FIELD OF THE INVENTION

This invention relates to a system, method and computer readable medium for controlling components in an optical network. In preferred embodiments, the invention relates to a system, method and computer readable medium for detecting and controlling specific transmission conditions in an Optical Network Termination (ONT) of an optical network.

### BACKGROUND OF THE INVENTION

ONT (Optical Network Termination), also called ONU (Optical Network Unit), refer to the consumer end equipment in an optical Fiber to the Home (FTTH) link. The ONT/ONU receives downstream data from the OLT (Optical Line Termination) through the passive optical splitters and provides video, voice, and broadband services to the consumer.

In the FTTH Passive Optical Network (PON) applications, ONT's are granted permission under control of the OLT to transmit upstream on a shared PON medium at specific assigned time slots. There exists the possibility of an ONT operating it's upstream transmit laser in an always on state operating within unassigned transmit timeslots. Detection and alleviation of this continuous transmission state is essential.

Various hardware methods exist to detect laser on times such as resettable “watchdog timers” which are reset by the normal laser enable control signal. If the control signal does not reset the watchdog timer then the timer times out and inhibits the transmit laser from coming on.

The known solutions require a hardware implementation and are not flexible as a software driven solution.

### SUMMARY OF THE INVENTION

It is an object of the present invention to overcome the disadvantages of the present invention by providing a software solution that allows predetermined transmission conditions, such as a continuous transmission state, to be detected and alleviated if necessary. Transmission states of the ONT can be determined by random sampling of the laser transmission via a software controlled processor within the ONT.

In one embodiment of the disclosure, there is provided an Optical Network Termination (ONT) comprising at least one processor, at least one transmission module and at least one transmission monitor. The at least one transmission module transmits upstream on an optical network, the transmission monitor is configured to measure at least one parameter of an upstream transmission, the at least one processor is configured to process the at least one measured parameter to determine whether the measured parameter indicates a predetermined transmission condition and the processor is adapted to adjust the operation of the transmission module if the predetermined transmission condition is indicated.

In one embodiment of the disclosure, there is provided a method of operating an Optical Network Termination comprising measuring at least one parameter of an upstream transmission, determining whether the measured parameter is indicative of a predetermined transmission condition, and adjusting the operation of the Optical Network Termination if the predetermined transmission condition is indicated.

In one embodiment of the disclosure, there is provided a computer readable medium comprising instructions executable in at least one processor of an Optical Network Termination for sampling at least one parameter of a laser transmission module, determining whether the sampled parameter is indicative of a predetermined transmission condition; and providing a signal to a laser transmission module to adjust the operation of the laser transmission module if the predetermined transmission condition is indicated.

In one embodiment, the predetermined transmission condition is a continuous transmission condition, in response to which, the upstream transmission is shut down.

### BRIEF DESCRIPTION OF THE DRAWINGS

The invention will now be described by way of example with reference to preferred embodiments and to the accompanying drawings in which:

FIG. 1 provides a schematic representation of an Optical Network Termination;

FIG. 2 provides a flow chart representing a method of operation of the Optical Network Termination of FIG. 1;

FIG. 3 provides a flow chart representing a method of detecting a continuous transmission state; and

FIG. 4 provides a flow chart representing a method of operating a processor of the Optical Network Termination.

### DETAILED DESCRIPTION OF PREFERRED EMBODIMENTS

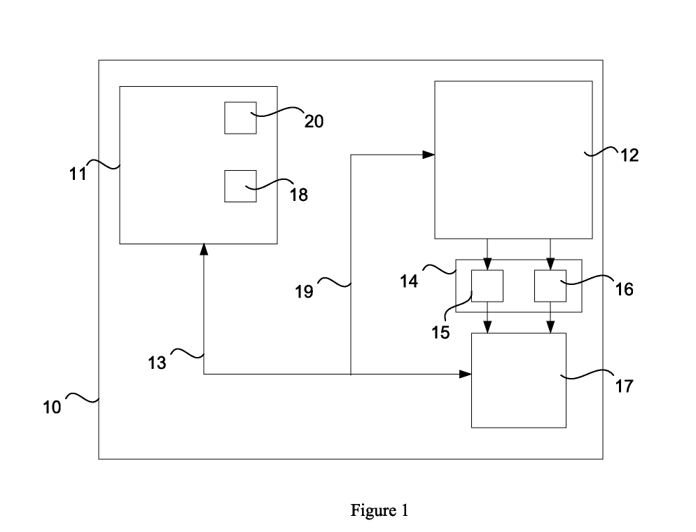

FIG. 1 shows an Optical Network Termination (ONT) 10 in accordance with one embodiment of the invention. The ONT 10 has a controller 11 including a processor 18 and a programmable memory 20. The programmable memory 20 stores the operating instructions in software which are run by the processor 18 for controlling the operation of the ONT. The controller 11 controls operation of the ONT laser modules, of which an upstream transmitting laser module 12 is shown, via any appropriate communication interface 13, for example an I²C line.

A transmission monitor 14 measures one or more parameters of the upstream transmission by the laser module 12. In one embodiment, the transmission monitor includes a bias current monitor 15 and a modulation current monitor 16. The transmission monitor signals are provided to an analogue to digital converter (ADC) 17. The digital values from the ADC 17 are made available on the I²C serial bus which can be read by the ONT controller 11 via a polling or interrupt mechanism.

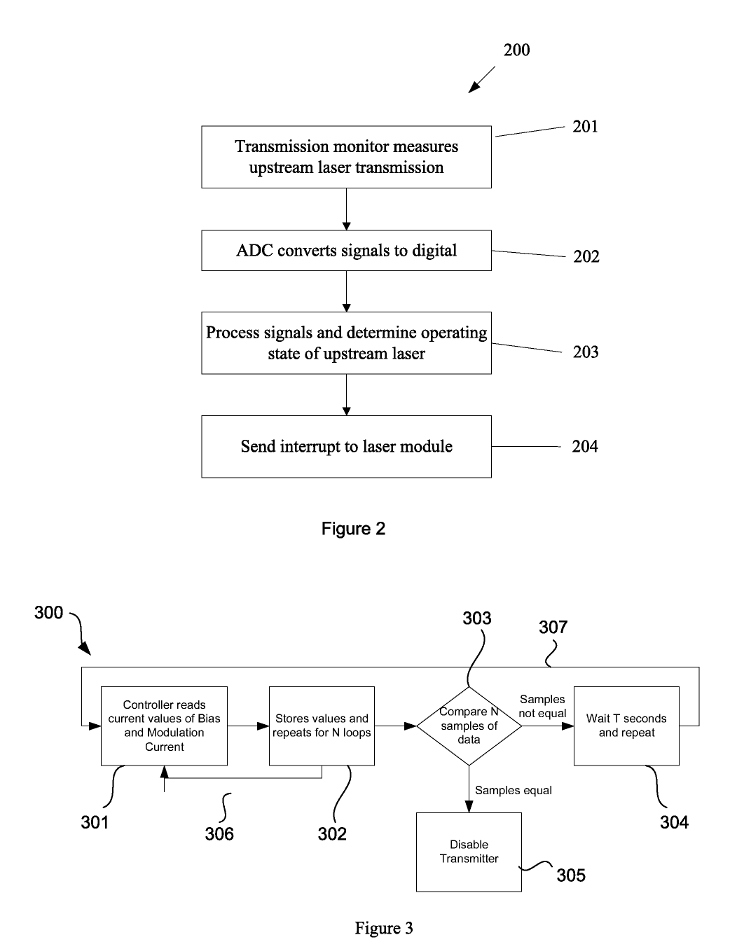

FIG. 2 provides a flow chart 200 for performing a method of operating the ONT 10 in accordance with one embodiment of the invention. The transmission monitor measures the upstream laser transmission (step 201). At step 202, the transmission monitor signals are converted to digital signals by the ADC 17. The controller processor 18 processes the digital signals to determine the state of operation of the upstream laser (step 203).

If the processor 18 determines that the signals indicate the laser module 12 is operating in a predetermined state, then the controller software causes an interrupt signal 19 to be sent to the laser module 12 to adjust the operation of the laser module 12 (step 204). In one preferred embodiment, the predetermined state is an always on state which, when detected, causes the controller 11 to shut down the transmission laser of the laser module 12. For example, if the level of transmission modulation current representing an “on” state is consistently detected in time equal to multiple 125 microsecond transmission frame intervals then the conclusion is the laser module is in an always on state. With this conclusion, the transmission laser is shut down by writing a transmit disable to the appropriate register of the laser module microcontroller (not shown).

A specific example for detecting a continuous transmission state will now be described with reference to the flow diagram 300 shown in FIG. 3. The controller 11 reads the bias current and modulation current at step 301. The values are stored (step 302) and the measurement process repeated for N loops, as indicated by loop 306. Once N samples have been collected, the N samples are compared (step 303). If the samples are all equal, for example, digitally represented as all ones, then the controller determines that the samples indicate a continuous transmission state. Based on this determination, the ONT controller software will shut down the laser module 12 via the I²C serial bus by writing a transmit disable to the appropriate register (step 305). If the samples are not equal, then the transmission state of the laser is varying, as per standard operation which requires only that the controller 11 wait a time T seconds (step 304) before repeating the loop 307.

Additional or alternative transmit disable mechanisms are possible. For example, the laser module Reset can be used to shut down only the optical transmit section of the module. In one embodiment, only the upstream laser need be disabled.

In the present example, the value for N representing the number of samples and the value T seconds representing the sample rate are both configurable parameters, as described below.

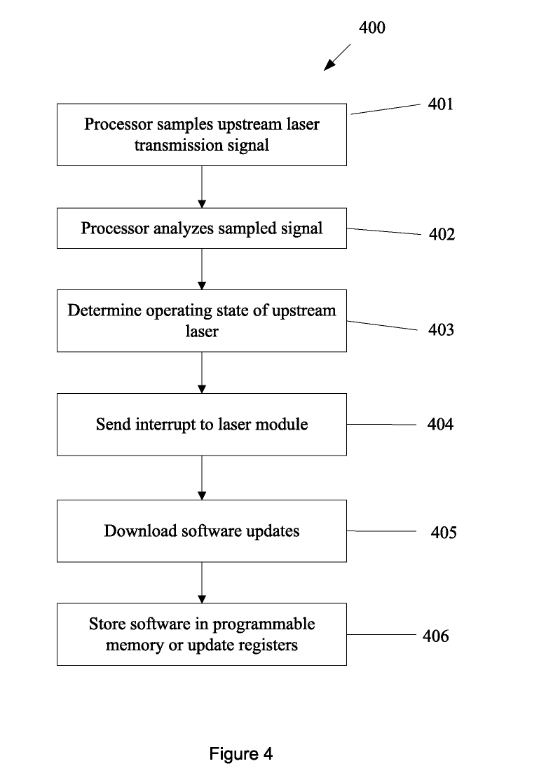

Not being fixed in hardware, the above described embodiments provide the flexibility of software changes to reconfigure any suitable aspect of the controlling software run by the processor 18. FIG. 4 provides a flow chart 400 from the perspective of the processor. At step 401, the processor 18 samples the output of the laser transmission module, ie the upstream laser transmission. In the present embodiments, the output of the laser transmission module is sampled via the transmission monitor 14 and ADC 17, however the skilled addressee will readily understand that other systems and methods for sampling the upstream laser transmission are possible. The processor analyzes the sampled signal (step 402), for example using the method described above with reference to FIG. 3, though modifications and substitutions of this analysis method will be readily apparent to the skilled addressee. After analyzing the laser transmission signal, if the processor determines that a predetermined transmission state exists (step 403), such as a continuous transmission state, the processor sends an interrupt signal (step 404) to the laser module. At step 405, the processor receives software updates, including any updates to the process routine parameters. For example, a software update may include changes to the sample rate, the method or range of values used in determining a predetermined transmission state, or the type of interrupt signal that is sent to the laser module. These software changes may be performed by downloading new software, ie new program instructions and storing the new instructions into the programmable memory of the ONT (step 406) through a suitable port (not shown). Alternatively, the reconfigurable parameters can be stored in distinct registers so that changes can be made by directly writing to those registers.

In addition, the ONT controller software typically has multiple accessible control points which can be accessed, for example to control the transmit burst enable and transmit data stream.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient.

What is claimed is:

1. An Optical Network Termination (ONT) comprising:
at least one processor;
at least one transmission module; and
at least one transmission monitor;
wherein the at least one transmission module transmits upstream on an optical network;
wherein the transmission monitor is configured to measure at least one parameter of an upstream transmission;
wherein the at least one processor is configured to process said at least one measured parameter to determine whether the measured parameter indicates a predetermined transmission condition; and
wherein the at least one processor is adapted to adjust the operation of the transmission module if said predetermined transmission condition is indicated.

2. The Optical Network Termination according to claim 1 further comprising at least one programmable memory, wherein the at least one programmable memory stores a set of program instructions for processing said at least one measured parameter.

3. The Optical Network Termination according to claim 2 wherein said set of instructions include instructions setting at least one of a rate of sampling of the at least one measured parameter and an adjustment of the operation of the transmission module.

4. The Optical Network Termination according to claim 3 wherein at least one of the rate of sampling of the at least one measured parameter and the adjustment of the operation of the transmission module are reconfigurable.

5. The Optical Network Termination according to claim 1 wherein the transmission monitor is at least one of a bias current monitor and a modulation current monitor.

6. The Optical Network Termination according to claim 1 wherein the predetermined transmission condition is a continuous transmission condition.

7. The Optical Network Termination according to claim 6 wherein the processor is configured to shut down the upstream transmission in response to determination of the continuous transmission condition.

8. A method of operating an Optical Network Termination comprising:
measuring at least one parameter of an upstream transmission;
determining whether said measured parameter is indicative of a predetermined transmission condition; and
adjusting the operation of the Optical Network Termination if said predetermined transmission condition is indicated.

9. The method according to claim 8 wherein measuring at least one parameter of an upstream transmission comprises measuring at least one of a modulation current and a bias current of an upstream laser transmission.

10. The method according to claim 8 wherein adjusting the operation of the Optical Network Termination comprises shutting down the upstream transmission.

11. The method according to claim 8 wherein said predetermined transmission condition is a continuous transmission condition.

12. The method according to claim 11 further comprising shutting down the upstream transmission in response to determination of the continuous transmission condition.

13. The method according to claim 11 comprising measuring N samples of said at least one parameter and comparing said N samples.

14. The method according to claim 13 wherein said continuous transmission condition is indicated by said N samples being equal.

15. A computer readable medium comprising instructions executable in at least one processor of an Optical Network Termination for:
sampling at least one parameter of a laser transmission module;
determining whether said sampled parameter is indicative of a predetermined transmission condition; and
providing a signal to a laser transmission module to adjust the operation of the laser transmission module if said predetermined transmission condition is indicated.

16. The computer readable medium according to claim 15 further comprising instructions for setting at least one of a rate of sampling of the at least one sampled parameter, analyzing the at least one sampled parameter, and an adjustment of the operation of the laser transmission module.

17. The computer readable medium according to claim 15 further comprising instructions for downloading changes to said instructions.

18. The computer readable medium according to claim 17 wherein said changes to said instructions comprises changes to at least one of a rate of sampling of the at least one sampled parameter, analyzing the at least one sampled parameter and the adjustment of the operation of the transmission module.

19. The computer readable medium according to claim 17 further comprising instructions for storing said changes in at least one of:
a programmable memory; and
at least one register.

20. The computer readable medium according to claim 15 comprising instructions for determining a continuous transmission condition and shutting down an upstream transmission of said Optical Network Termination.
